(19) United States
(12) Patent Application Publication
(10) Pub. No.: US 2026/0100129 A1
(43) Pub. Date: Apr. 9, 2026

(54) DRIVER ASSISTANCE SYSTEMS AND METHODS FOR MERGE GUIDANCE

(71) Applicant: Stack AV Co., Mount Pleasant, PA (US)

(72) Inventors: Jeremy Lawrence SEAROCK, Glenshaw, PA (US); Dennis Jeffrey HOFF, South Park Township, PA (US)

(73) Assignee: Stack AV Co., Mount Pleasant, PA (US)

(21) Appl. No.: 18/911,117

(22) Filed: Oct. 9, 2024

(51) Int. Cl. G08G 1/16; G08G 1/052

(52) U.S. Cl. CPC G08G 1/166; G08G 1/052

(57) ABSTRACT

A method for a driver assistance system of a driver's vehicle is provided. The method comprises detecting a location of the driver's vehicle and a lane that the driver's vehicle is traveling along; identifying a nearby vehicle in a vicinity of the driver's vehicle based on sensor data; identifying a lane that the nearby vehicle is traveling along based on the location of the driver's vehicle, map data comprising traffic lane information, and the sensor data; determining, based on the driver's vehicle lane and the nearby vehicle lane, that the driver's vehicle lane and the nearby vehicle lane will merge; and outputting a driver alert based on the determination.

### FIELD

The present disclosure relates generally to driver assistance systems and methods, and more specifically to vehicle merge guidance systems and methods.

### BACKGROUND

Automotive accidents may frequently occur on highways or other high traffic thoroughfares at locations where two lanes merge into one, such as entrance or exit ramps, or points at which the number of lanes is reduced. Additionally, collisions between two or more vehicles may frequently occur when one vehicle changes lanes without a sufficient gap or spacing between vehicles in the target lane to accommodate the vehicle making the change.

In both instances, a partial cause of resulting collisions may be an absence of information or knowledge about future changes in lane configuration and/or about the position and velocity of surrounding vehicles, or about the intention of drivers of such vehicles. Known techniques may address such a lack of knowledge by alerting a driver to collision risks in proximate to the driver's vehicle, for example a vehicle located in the lane adjacent to the driver's vehicle, without addressing vehicles located further away, upcoming changes in lane configuration, or driver intent.

### SUMMARY

Described herein are systems and methods that may provide a driver guidance on handling upcoming merges involving the lane the driver's vehicle is traveling along and/or lane changes planned by the driver or expected by other vehicles. Such systems and methods may detect and track vehicles located not only in lanes adjacent to the driver's vehicle but additionally those located in more distant lanes, and may use knowledge of the driver's vehicle location and map data to determine collision risks based on changes to lane configuration taking place in the near future. In addition, disclosed systems may monitor the state of indicator lights such as turning signals and/or hazard lights on the driver's vehicle and on vehicles in the vicinity of the driver's vehicle to evaluate the risk of collision if one or more vehicles were to change lanes.

The disclosed systems and methods may first process data from a first sensor to detect one or more lane lines of the roadway along which the driver's vehicle is traveling, from a GPS satellite receiver to determine an estimate of the driver's vehicle position, and from a second sensor to detect one or more nearby vehicles. An exemplary system may then compute the driver's vehicle location using the one or more lane lines and the GPS satellite data in combination with map data that includes traffic lane information before using the computed location and map data to identify a lane along which the driver's vehicle is traveling. The positions of lane lines in the map data may then be added to the data from the second sensor based on the computed driver's vehicle location and/or on lane line positions detected in the data from the second sensor to identify the lane along which the detected one or more nearby vehicles are traveling.

An exemplary system may next compare the identified driver's vehicle lane and nearby vehicle lane with the map data based on the computed driver's vehicle location to determine whether the driver's vehicle lane and nearby vehicle lane will merge in the near future, for example at some distance along the roadway in front of the driver's vehicle. If the system determines a lane merge will occur, it may compute an estimated distance between the driver's vehicle and the nearby vehicle based on computations of the nearby vehicle's and/or driver's vehicle's location and/or velocity. Alternatively or additionally, the system may detect the use of a turning signal on the driver's vehicle and/or the nearby vehicle and may determine the probability the driver's vehicle will change lanes and enter the nearby vehicle's lane or the nearby vehicle will change lanes and enter the driver's vehicle lane. Based on this probability, the system may compute the estimated distance between the driver's vehicle and the nearby vehicle at an expected lane change location based on computations of the driver's vehicle's and/or nearby vehicle's location and/or velocity.

An exemplary system may then output a driver alert if the estimated distance between the nearby vehicle and the driver's vehicle represents a collision risk to the driver's vehicle. This may determined by comparing the estimated distance to a proximity threshold which may be based on a user's or a driver's risk tolerance, and/or the classification of the nearby vehicle and/or the driver's vehicle, for example semi-truck, which may provide an estimate of the stopping distance of the nearby vehicle and/or the driver's vehicle. The driver alert may take the form of an indication light, an audible tone and/or output, a haptic output, an electronic signal transmission, and/or a visual display and/or user interface-based alert that may include an updated top-down view of the roadway that highlights the one or more nearby vehicles posing a collision risk and/or a preferred merge area in an adjacent lane. The system may also provide an estimate of the distance to the lane merge or lane change and may provide recommendations on how to modulate the velocity of the driver's vehicle to mitigate the collision risk.

In some embodiments, a method for a driver assistance system of a driver's vehicle is provided, the method comprising detecting a location of the driver's vehicle and a lane that the driver's vehicle is traveling along; identifying a nearby vehicle in a vicinity of the driver's vehicle based on sensor data; identifying a lane that the nearby vehicle is traveling along based on the location of the driver's vehicle, map data comprising traffic lane information, and the sensor data; determining, based on the driver's vehicle lane and the nearby vehicle lane, that the driver's vehicle lane and the nearby vehicle lane will merge; and outputting a driver alert based on the determination.

In some embodiments, detecting the location of the driver's vehicle is based on global positioning system satellite data. In some embodiments, detecting the location of the driver's vehicle and the lane that the driver's vehicle is traveling along is based on matching one or more detected lane lines of a roadway that the driver's vehicle is traveling along to the map data comprising traffic lane information. In some embodiments, detecting the location of the driver's vehicle and the lane that the driver's vehicle is traveling along is based on global positioning system satellite data, the map data comprising traffic lane information, and one or more detected lane lines of a roadway that the driver's vehicle is traveling along. In some embodiments, identifying the nearby vehicle lane comprises adding the map data comprising traffic lane information to the sensor data and determining that a nearby vehicle lane confidence metric meets a nearby vehicle lane threshold. In some embodiments, determining that the driver's vehicle lane and the nearby vehicle lane will merge is further based on the map data comprising traffic lane information. In some embodiments, outputting the driver alert comprises computing a nearby vehicle location and a nearby vehicle velocity based on the driver's vehicle location, the map data, and the sensor data. In some embodiments, outputting the driver alert comprises computing an estimated distance between the driver's vehicle and the nearby vehicle at a location of the merge based on the driver's vehicle location, a driver's vehicle velocity, the nearby vehicle location, and the nearby vehicle velocity. In some embodiments, outputting the driver alert is further based on a determination that the estimated distance between the driver's vehicle and the nearby vehicle at the location of the merge meets a proximity threshold. In some embodiments, outputting the driver alert comprises at least one of illuminating an indication light or generating an audible tone. In some embodiments, outputting the driver alert comprises displaying, on a user interface, at least one of an indication of the nearby vehicle, a recommended merge location, or a recommendation to modify or maintain a velocity of the driver's vehicle.

In some embodiments, a method for a driver assistance system of a driver's vehicle is provided, the method comprising detecting a location of the driver's vehicle and a lane that the driver's vehicle is traveling along; identifying a nearby vehicle in a vicinity of the driver's vehicle based on sensor data; identifying a lane that the nearby vehicle is traveling along based on the location of the driver's vehicle, map data comprising traffic lane information, and the sensor data; computing a probability, based on the driver's vehicle lane and the nearby vehicle lane, that at least one of the following will occur: the driver's vehicle will enter the nearby vehicle lane or the nearby vehicle will enter the driver's vehicle lane; and outputting a driver alert based on the probability.

In some embodiments, detecting the location of the driver's vehicle is based on global positioning system satellite data. In some embodiments, detecting the location of the driver's vehicle and the lane that the driver's vehicle is traveling along is based on matching one or more detected lane lines of a roadway that the driver's vehicle is traveling along to the map data comprising traffic lane information. In some embodiments, detecting the location of the driver's vehicle and the lane that the driver's vehicle is traveling along is based on global positioning system satellite data, the map data comprising traffic lane information, and one or more detected lane lines of a roadway that the driver's vehicle is traveling along. In some embodiments, identifying the nearby vehicle lane comprises adding the map data comprising traffic lane information to the sensor data and determining that a nearby vehicle lane confidence metric meets a nearby vehicle lane threshold. In some embodiments, determining the probability is further based on detecting use of a turning signal on at least one of the driver's vehicle or the nearby vehicle. In some embodiments, outputting the driver alert comprises computing a nearby vehicle location and a nearby vehicle velocity based on the driver's vehicle location, the map data, and the sensor data. In some embodiments, outputting the driver alert comprises computing an expected lane change location and an estimated distance between the driver's vehicle and the nearby vehicle at the expected lane change location based on the driver's vehicle location, a driver's vehicle velocity, the nearby vehicle location, and the nearby vehicle velocity. In some embodiments, outputting the driver alert is further based on a determination that the estimated distance between the driver's vehicle and the nearby vehicle at the expected lane change location meets a proximity threshold. In some embodiments, outputting the driver alert comprises at least one of illuminating an indication light or generating an audible tone. In some embodiments, outputting the driver alert comprises displaying, on a user interface, at least one of an indication of the nearby vehicle, a recommended lane change location, or a recommendation to modify or maintain a velocity of the driver's vehicle.

In some embodiments, a driver assistance system of a driver's vehicle is provided, the driver assistance system comprising a first sensor to detect one or more lane lines of a roadway that the driver's vehicle is traveling along; a second sensor to detect a nearby vehicle in a vicinity of the driver's vehicle; a global positioning system satellite receiver; and one or more processors and memory storing instructions that, when executed by the one or more processors, cause the system to detect a location of the driver's vehicle and a lane that the driver's vehicle is traveling along; identify a nearby vehicle in a vicinity of the driver's vehicle using data from the second sensor; identify a lane that the nearby vehicle is traveling along based on the location of the driver's vehicle, map data comprising traffic lane information, and data from the second sensor; compute, based on the driver's vehicle lane and the nearby vehicle lane, a probability that at least one of the following will occur: the driver's vehicle will enter the nearby vehicle lane, the nearby vehicle will enter the driver's vehicle lane, or the driver's vehicle lane and the nearby vehicle lane will merge; and output a driver alert based on the probability.

A non-transitory computer readable storage medium storing instructions for a driver assistance system of a driver's vehicle, wherein the instructions, when executed by one or more processors of an electronic device, cause the device to detect a location of the driver's vehicle and a lane that the driver's vehicle is traveling along; identify a nearby vehicle in a vicinity of the driver's vehicle using data from the second sensor; identify a lane that the nearby vehicle is traveling along based on the location of the driver's vehicle, map data comprising traffic lane information, and data from the second sensor; compute, based on the driver's vehicle lane and the nearby vehicle lane, a probability that at least one of the following will occur: the driver's vehicle will enter the nearby vehicle lane, the nearby vehicle will enter the driver's vehicle lane, or the driver's vehicle lane and the nearby vehicle lane will merge; and output a driver alert based on the probability.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

The patent or application file contains at least one drawing executed in color. Copies of this patent or patent application publication with color drawings(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for driver assistance, according to some embodiments.

FIG. 1B depicts an exemplary placement of system components on a vehicle, according to some embodiments.

FIG. 1C depicts an exemplary process for driver assistance involving a lane merge scenario, according to some embodiments.

FIG. 1D depicts an exemplary process for driver assistance involving a lane change scenario, according to some embodiments.

FIG. 2 depicts an exemplary addition of lane line map data to sensor data, according to some embodiments.

FIG. 3A depicts an exemplary user interface relating to a first lane merge scenario, according to some embodiments.

FIG. 3B depicts an exemplary user interface relating to a second lane merge scenario, according to some embodiments.

FIG. 4 depicts an exemplary user interface relating to a third lane merge scenario, according to some embodiments.

FIG. 5 depicts an exemplary computing system, according to some embodiments.

### DETAILED DESCRIPTION

Disclosed herein are systems and methods that may alert a driver of nearby vehicles in the vicinity of the driver's vehicle that may pose collision risks due to upcoming lane merges or anticipated lane changes by the driver's vehicle and/or one or more nearby vehicles, and that may provide recommended response options. To monitor a roadway a driver's vehicle is traveling along, disclosed systems may first process data from an image sensor that may be forward-facing, to generate image data comprising one or more lane lines in the vicinity of the driver's vehicle. GPS satellite data generated by a GPS satellite receiver may also be processed, which in combination with image data revealing lane line geometry may enable computation of the location of the driver's vehicle. In combination with map data including traffic lane information, computed driver's vehicle location may be used to identify the lane the driver's vehicle is traveling along. As discussed below, an exemplary system may detect the location and lane of a nearby vehicle, and alert the driver based on a detected lane merge and/or lane change involving the driver's vehicle and/or the nearby vehicle.

To detect nearby vehicles in the vicinity of the driver's vehicle, disclosed systems may process data from a second sensor. Map data including lane line locations may be added to this data, based on the computed driver's vehicle location and/or on lane line positions detected in the data from the second sensor, to identify a lane a detected nearby vehicle is traveling along. Disclosed systems may compute a nearby vehicle lane confidence metric, corresponding to the confidence that the detected nearby vehicle is in the identified nearby vehicle lane, and may determine further response based on the value of the nearby vehicle lane confidence metric.

Disclosed systems may also monitor map data for upcoming changes in lane configuration that may involve the lane of the driver's vehicle. For example, the map data may reveal an upcoming lane merge in the form of an entrance ramp and/or a lane reduction. Such a change in a lane configuration may be a cause for driver caution if one or more nearby vehicles are expected to remain in the vicinity of the driver's vehicle at the location of the merge. An exemplary system may compute the estimated distance between the nearby vehicle and the driver's vehicle at the location of an upcoming lane merge by first computing the location and velocity of the nearby vehicle based on one or more of the driver's vehicle location, the driver's vehicle velocity, or data from the second sensor including the nearby vehicle. Computed nearby vehicle location and velocity may be combined with the driver's vehicle velocity and location to compute the estimated distance between the nearby vehicle and the driver's vehicle at the merge location.

Disclosed systems may also monitor indicator lights such as turning signals on nearby vehicles and on the driver's vehicle. Detection of use of a turning signal may be used to determine the probability that the nearby vehicle may enter the lane of the driver's vehicle and/or that the driver's vehicle may enter the lane of the nearby vehicle. To determine the risk associated with such a lane change, an exemplary system may compute the nearby vehicle location and velocity and use it in combination with the driver's vehicle location and velocity to compute the expected location at which the lane change will occur and the estimated distance between the driver's vehicle and the nearby vehicle at the expected lane change location.

Disclosed systems may determine whether the estimated distance between the driver's vehicle and the nearby vehicle, at the point of a forced lane merge or at the expected point of a lane change by one or both vehicles, meets a proximity threshold and thus warrants the attention of the driver. If the estimated distance does meet such a proximity threshold, an exemplary system may alert the driver using one or more techniques including, for example, illumination of an indicator light, generation of an audible tone and/or output, or outputting of an alert on a user interface that may depict the nearby vehicles of concern and/or recommend steps the driver may take to mitigate collision risk.

Systems and methods described herein may thus have several advantages over known techniques. Known techniques may only monitor and alert a driver of vehicles immediately proximate to the driver's vehicle, for example not responding to nearby vehicles located two lanes over. Further, known techniques may not localize a driver's vehicle onto a map containing lane line information, thereby determining the lane of a nearby vehicle of concern and/or an upcoming change in lane configuration that may increase the risk of collision between a nearby vehicle and the driver's vehicle. Known techniques may also not monitor indicator lights or turning signals to anticipate an upcoming shift in lane occupancy by the driver or a driver of a nearby vehicle. Disclosed systems and methods may instead combine multiple sources of data such as the observed location and velocity of a nearby vehicle, the location and velocity of the driver's vehicle, with map data and indicator light status to estimate upcoming collision risk of collision with a nearby vehicle. Future collision risk may be estimated by computing the driver's vehicle's proximity to nearby vehicles at an upcoming lane merge or lane change location, thereby providing more intelligent, forward-looking notifications for drivers relative to those associated with known techniques.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

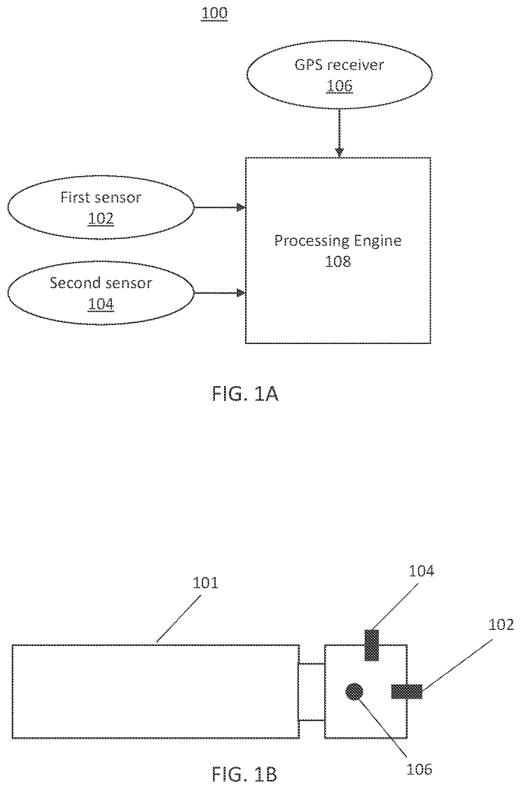

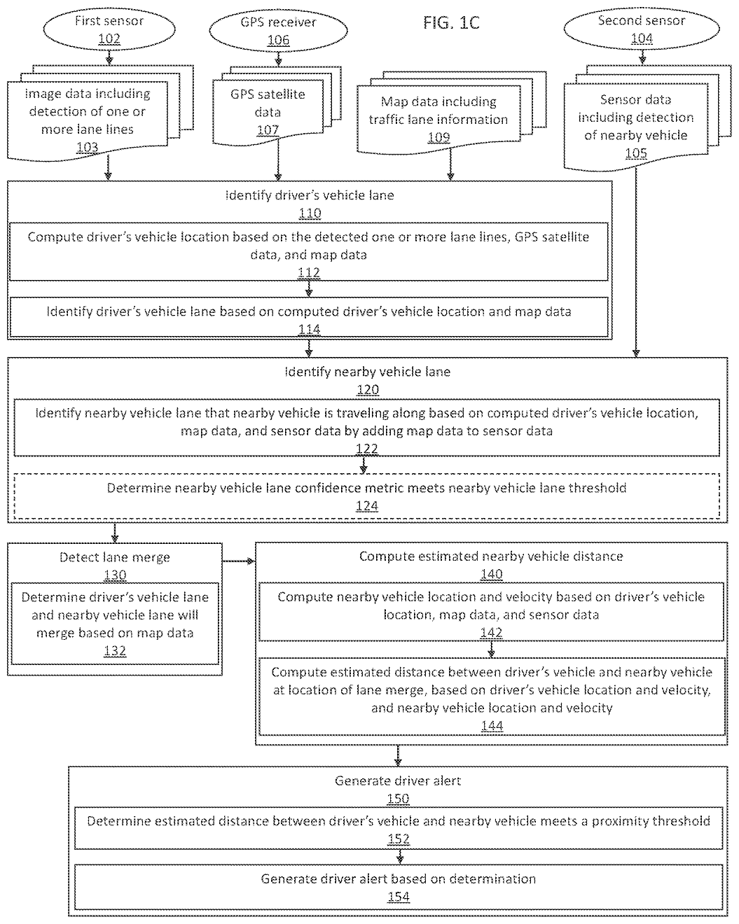

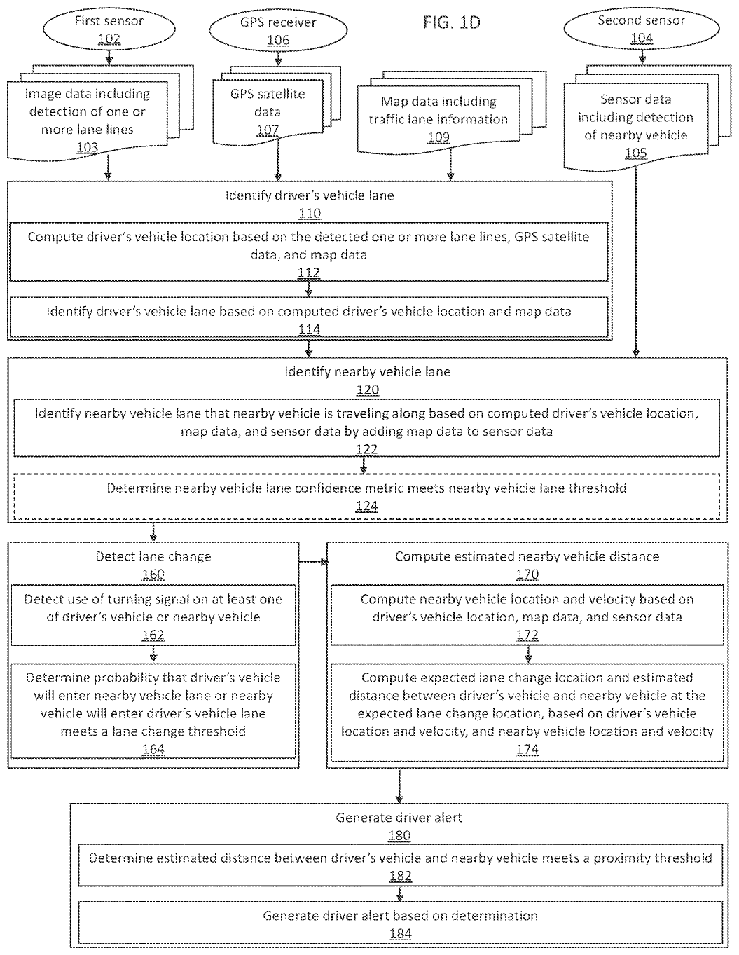

FIG. 1A depicts an exemplary system 100 which may be used to alert a driver of a vehicle to the collision risk posed by vehicles in the vicinity of the driver's vehicle. System 100 may be attached to the driver's vehicle and include a first sensor 102 that may include an image sensor that may be mounted to the roof or sides mirrors of the driver's vehicle, and may be forward-facing. First sensor 102 may have a sufficient field-of-view to capture the at least the lane lines of the lane along which the driver's vehicle is traveling, at least the lane lines of the lane along which the driver's vehicle is traveling and the lane lines of the adjacent lanes, or at least all of the lane lines of the roadway along which the driver's vehicle is traveling.

System 100 may also include a second sensor 104 that may include an image sensor mounted to the roof or side mirrors of the driver's vehicle, and may be side-facing. First sensor 102 and/or second sensor 104 may include, for example, a standard field-of-view camera, a wide field-of-view camera or camera with a fisheye lens, for example based on photodiodes, phototransistors, charge-coupled devices, complementary metal-oxide-semiconductor sensors, and/or photoresistors. First sensor 102 and/or second sensor 104 may additionally or alternatively include an infrared camera. Second sensor 104 may additionally or alternatively include a LiDAR sensor, a radar sensor, and/or a sonar sensor. Second sensor 104 may have a sufficient field-of-view to view objects and/or vehicles located behind, to the side of, and in front of the driver's vehicle. System 100 may further include Global Positioning System (GPS) satellite receiver 106 to communicate with one or more satellites to approximate the position of the driver's vehicle. GPS satellite receiver 106 employ one or more technologies to improve locational accuracy including, for example, Standard Positioning Service, Differential GPS, Real-Time Kinematic, Assisted GPS, and/or Wide Area Augmentation System.

Each of the first sensor 102, second sensor 104, and GPS satellite receiver 106 may be communicatively coupled to processing engine 108. Processing engine 108 may include one or more processors, and may be configured to execute instructions stored in a memory or other computer-readable media to cause system 100 to process data generated by first sensor 102, second sensor 104, and GPS satellite receiver 106, enabling system 100 to identify a driver's vehicle lane and/or a nearby vehicle lane, detect a potential lane merge or lane change, compute the estimated distance between the driver's vehicle and the nearby vehicle, and/or output a driver alert. For example, processing engine 108 may include computer 500 as discussed in the context of FIG. 5.

FIG. 1B depicts an exemplary placement of system components including first sensor 102, second sensor 104, GPS satellite receiver 106, on the driver's vehicle, in this case semi-truck 101. In the exemplary configuration depicted, first sensor 102 is forward-facing while second sensor 104 is side-facing. First sensor 102 and/or second sensor 104 may be mounted in different configurations, with first sensor 102 and/or second sensor 104 facing, for example, the front, the right side, the left side, and/or the rear of vehicle 101. System 100 may include one or more additional sensors which in turn may face, for example, the front, the right side, the left side, and/or the rear of vehicle 101. Similarly, in the exemplary configuration depicted, GPS satellite receiver 106 is located at the center of the truck. GPS satellite receiver 106 may be located closer to the edge of vehicle 101 and/or may be mounted to on the side of vehicle 101. System 100 may include one or more additional GPS satellite receivers that may be mounted at the top and/or on the side of vehicle 101.

FIG. 1C depicts an exemplary process by which system 100 may be used to identify the lanes along which the driver's vehicle and a nearby vehicle are traveling, detect an upcoming lane merge involving the driver's vehicle's lane, and estimate the proximity of the nearby vehicle to the driver's vehicle at the location of the merge before optionally outputting an alert to notify the driver of a potential collision risk.

First sensor 102 may be forward-facing and may generate image data 103 which may include one or more lane lines, for example including the lane lines of the lane along which the driver's vehicle is traveling as mentioned above. To determine the location and shape of lane lines within data 103, system 100 may employ one or more feature-detection algorithms that may be based on convolutional neural networks, transformer networks, and/or other machine-learning based detection. System 100 may be trained on datasets that include images of lane lines viewed from a similar perspective as that of first sensor 102 in a variety of environmental conditions. If image data 103 includes lens distortion, for example resulting from use of a wide field-of-view sensor, system 100 may apply one or more lens distortion correction algorithms to data 103 to improve detection of the one or more lane lines of the roadway, for example through the use of feature-detection algorithms trained on non-distorted data.

GPS satellite receiver 106 as mentioned above may generated GPS satellite data 107 that in combination with image data 103 may enable localization of the driver's vehicle to which system 100 is attached. The exemplary process of FIG. 1C may also take as an input map data 109 including traffic lane information including data related to one or more roadways to which system 100 is likely to be exposed. Map data 109 may include all roadways of a particular region, province, or country which system 100 may operate or it may include all navigable roadways for which lane line data is available. Map data 109 may be updated based on recently constructed roadways or changes in traffic patterns so as to reflect the latest lane configurations. Map data 109 may be updated in real-time and include temporary lane closures resulting from, for example, construction work, automotive accidents, weather events, or parades. Such updates may be provided by any real-time over-the-air source, for example existing providers such as Google Maps and/or custom providers that system 100 may be connected over a network to.

Image data 103, GPS satellite data 107, and/or map data 109 may be used by system 100 at step 110 to identify the lane along which the driver's vehicle is traveling. To accomplish this, at step 112, system 100 may produce an initial estimate of driver's vehicle location using GPS data 109. Since the accuracy of GPS may depend on several factors and may at best geolocate a GPS satellite receiver such as GPS satellite receiver 106 to less than five meters, system 100 may combine the initial estimate produced by processing GPS satellite data 107 with image data 103, specifically the one or more detected lane lines and lane line configuration that may be contained in data 103, along with map data 109 to produce a lower tolerance estimate of the location of system 100 and thus of the driver's vehicle. Unique aspects of the detected lane line configuration that in combination with GPS data may reveal the driver's vehicle location may include, for example, the number and/or color of each lane line, whether each line is solid, broken, or dashed, and/or bends in the roadway and thus in the lane lines. By using GPS satellite data 107 to determine an estimated position of system 100 within map data 109, system 100 may combine unique aspects of lane line configuration in image data 103 with map data 109 in the vicinity of the estimated position to produce a higher resolution or lower tolerance estimate of the position of system 100, thereby computing the driver's vehicle location. This higher accuracy estimate of the position of system 100 may in turn improve the accuracy of the identified lane along which detected nearby vehicles are traveling as discussed below in the context of step 120. Alternatively or additionally, system 100 may use unique aspects of lane line configuration in image data 103 in combination with map data 109 to produce an estimated position of system 100, without input from GPS satellite data 107, for example in instances in which GPS satellite receiver 106 has poor or intermittent satellite connectivity.

With driver's vehicle location computed at step 112, system 100 may at step 114, identify the lane the driver's vehicle is traveling along. For example, system 100 may identify the driver's vehicle lane based on the computed driver's vehicle location using map data 109. That is, map data 109 may allow identification of the driver's vehicle lane based on the driver's vehicle location, optionally expressed in latitude and longitude. As an additional or alternative method, system 100 may identify the driver's vehicle lane based on a combination of unique aspects of lane line configuration in image data 103 with map data 109 as detailed above. System 100 may improve the accuracy and/or efficiency of the identification of the driver's vehicle lane by using GPS satellite data 107 to determine an estimated position of system 100 within map data 109 as described above.

Second sensor 104, which may be a number of different sensor types, and may be side-facing, may generate sensor data 105 that may include detection of one or more nearby vehicles. To extract features that may correspond to nearby vehicles within data 105, system 100 may employ one or more vehicle-detection algorithms that may be based on convolutional neural networks, transformer networks, and/or other machine-learning based detection. System 100 may be trained on datasets that include images of vehicles viewed from a similar perspective as that of second sensor 104 in a variety of environmental conditions.

Extraction of image features corresponding to a nearby vehicle may involve identifying a region corresponding to the nearby vehicle using a bounding box or other shape, or by identifying points of interest, or keypoints, corresponding to a nearby vehicle. Locations of detected data, for example, pixel coordinates of the top-left corner of a bounding box along with its height and width may be stored in a separate file and associated with the corresponding image. Additional parameters related to the detection of the nearby vehicle, for example, an identification confidence metric, or an vehicle classification, may additionally be stored. As mentioned above, system 100 is not restricted to detection of nearby vehicles in a lane adjacent to the driver's vehicle and may instead detect and track nearby vehicles located at least one, at least two, or at least three lanes from the driver's vehicle to maintain awareness of nearby vehicles that may pose a future collision risk.

In some implementations, system 100 may not act on a nearby vehicle detection unless the identification confidence metric meets an optionally user-defined identification threshold value, for example by exceeding the threshold. As with image data 103, if second image data 105 includes lens distortion, for example resulting from use of a wide field-of-view sensor, system 100 may apply one or more lens distortion correction algorithms to data 105 to improve nearby vehicle detection, for example through the use of feature-detection algorithms trained on non-distorted data.

The purposes and orientations of first sensor 102 and second sensor 104 may not be limited to the above-described implementations. That is, first sensor 102 and/or second sensor 104 may be oriented in a forward-facing or side-facing manner and may be used in either orientation for generation of data containing one or more lane lines and/or one or more vehicles in the vicinity of the driver's vehicle. As a first example, data generated by second sensor 104 may be used to detect lane lines and/or to verify or confirm the lane line configuration or geometry detected by first sensor 102, e.g. one or both of image data and sensor data may be used for lane line detection. As a second example, data generated by sensor 102 may analyzed using a vehicle-detection algorithm to monitor for nearby vehicles and/or objects, with additional parameters corresponding to a detection being stored in a similar manner to that described above, e.g. one or both of image data and sensor data may be used for vehicle detection. Use of a forward-facing, standard field-of-view first sensor 102 may be advantageous in providing a low distortion, high resolution view of lane lines and/or detection of lane lines using a wider range of feature-detection algorithms, while use of a side-facing, wide field-of-view second sensor 104 may be advantageous to detect vehicles behind, adjacent to, and/or in front of the driver's vehicle.

Detection of lane lanes, vehicles, and/or objects by detection algorithms may take place in real-time with each frame of sensor data being analyzed as it is generated. Alternatively or additionally, each frame may be analyzed by batching frames of sensor data, and analyzing each batch using a detection algorithm. System 100 may automatically switch between the two analytical modes and may base a decision of whether to analyze in real-time or to batch data before analysis on the available computational resources associated with processing engine 108.

Sensor data which may, as discussed above, include additional parameters related to detection of one or more nearby vehicles may be combined at step 120 with the computed driver's vehicle location and map data 109 to identify the lane along which the detected nearby vehicle is traveling. Specifically, at step 122, system 100 may use the computed location of the driver's vehicle and sensor data 105, optionally including a side-facing view of the roadway, to identify a portion of map data 109 and specifically lane line location information within the map data, that matches that of the view of sensor data 105, so as to identify the lane along which the detected nearby vehicle is traveling. Here, as with the generation of a correspondence between lane line configuration and driver's vehicle location at step 112, system 100 may use the features or configuration of lane lines detected in sensor data 105 to identify a matching portion of map data 109. Alternatively or additionally, system 100 may take as an input a mounting angle of second sensor 104 and use this as an initial estimate of the portion of map data 109 that matches the view of the second sensor 104. For example, if second sensor is mounted at a rotation of positive 90 degrees about the vertical axis of system 100 or of the driver's vehicle, e.g. facing to the driver's left, system 100 may assume for estimation purposes that the driver's vehicle is aligned to the lane line and check a portion of map data corresponding to the driver's vehicle location facing left relative to the driver's vehicle's lane's direction of travel. System 100 may refine this initial estimate based on the features present in sensor data 105, including the configuration of lane lines including, for example, the number and/or color of each lane line, whether each line is solid, broken, or dashed, and/or bends in the roadway and thus in the lane lines.

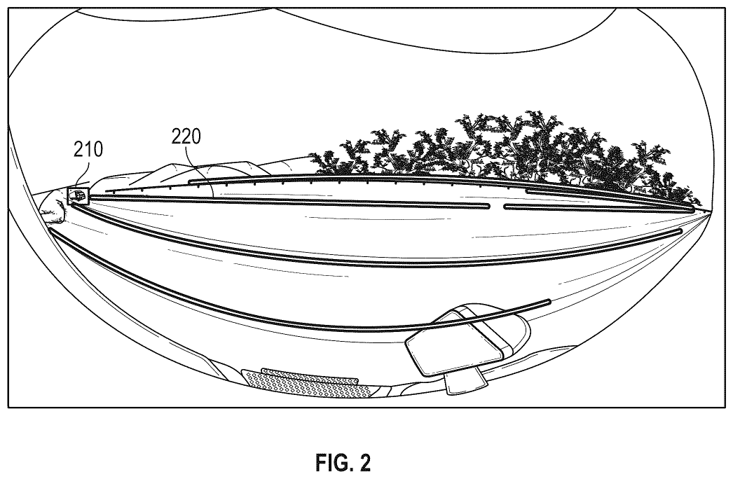

With a portion of map data 109 identified that matches sensor data 105, system 100 may add data corresponding to one or more lane lines in the portion of map data to sensor data 105 based on the computed driver's vehicle location and/or on lane line detections in sensor data 105, thereby augmenting sensor data 105 with an alternate sources of lane line data. For example, FIG. 2 depicts exemplary sensor data 105 in the form of an image sensor with a wide field-of-view. Here, a vehicle-detection algorithm was applied to the sensor data, and a nearby vehicle 210 was detected and a bounding box was placed around the nearby vehicle to indicate its position and optionally store information corresponding to the detection. Additionally depicted in FIG. 2 are lane line data 220 which were added to the sensor data following computation of the location of the driver's location and use of that location in combination with the sensor data and map data 109 to determine the portion of the map data matching the sensor view, before adding to the sensor data corresponding lane line information. With a nearby vehicle detected and lane line information added to sensor data 105, system 100 may identify the most likely nearby vehicle lane based on which of the lane lines surround the nearby vehicle detection. System 100 may then assign a nearby vehicle lane confidence metric to this determination as described below.

While addition of lane line information from map data 109 is one method of deriving the position of lane lines present in sensor data 105, it is not the only method system 100 may employ at step 122. System 100 may additionally or alternatively use image data 103 and/or sensor data 105 that include detections of lane lines or portions of lane lines to extrapolate and/or connect lane line portions to infer the location of one or more visible lane lines. In such a case, as described above, system 100 may use a feature-detection algorithm that may include a convolutional neural network and/or may be trained on a dataset comprising views of lane lines from a variety of angles and/or corresponding to a variety of atmospheric conditions. If lens distortion is present in image data 103 and/or sensor data 105, for example from a wide field-of-view sensor, system 100 may apply one or more lens distortion correction algorithms to reduce distortion in the images which may make available to system 100 for use a wider range of feature-detection algorithms or networks. By instead adding lane line information from map data 109, system 100 may be less sensitive to reductions in the quality of lane line sections detected in sensor data 105, for example missing or less contrastive sections, and may thus produce a more reliable and consistently accurate determination of lane line position within sensor data 105.

In addition to one or more identification confidence metrics that may be generated in concert with identifying a nearby vehicle in sensor data 105, system 100 may additionally or alternatively generate a nearby vehicle lane confidence metric associated with the identification of the lane along which the nearby vehicle is traveling. The confidence metric associated with this identification may vary based, for example, on system 100's confidence in the locations of lane lines added from map data 109 and/or directly detected by first sensor 102 or second sensor 104. The confidence metric may also incorporate the identification confidence metric, that is a lower confidence detection of a nearby vehicle or the nearby vehicle's location may translate to a lower confidence nearby vehicle lane identification. System 100 may modulate the manner in which further collision risk detection and computation steps are taken based on a determination that the nearby vehicle lane confidence metric meets an optionally user-defined nearby vehicle lane confidence threshold, for example by exceeding the threshold. As a first example, if the confidence metric does not meet the nearby vehicle lane confidence threshold, system 100 may choose to not respond further to the nearby vehicle until the confidence metric increases. As a second example, if the confidence metric does not meet the nearby vehicle lane confidence threshold, system 100 may choose to proceed on the basis that it is met, out of caution, and/or may choose to preemptively alert the driver to the location of the nearby vehicle, as the driver may have a better perspective or ability to identify the nearby vehicle as forming a future collision risk.

Once a lane along which the driver's vehicle is traveling and a lane along which a nearby vehicle is traveling have been identified, system 100 may next check for one or more situations that may produce a risk of collision between the driver's vehicle and the nearby vehicle in the near future. One such situation system 100 may check for includes the merger of the lane the driver's vehicle is traveling along with the lane the nearby vehicle is traveling along. Such a merger between the driver's vehicle lane and nearby vehicle lane may occur in a plurality of scenarios including the driver's vehicle or the nearby vehicle merging with a roadway from an entrance ramp, or a reduction in the number of lanes involving the driver's vehicle lane and the nearby vehicle lane. Such situations may be referred to as “forced” lane merges, have a particular location at which the merge must occur by on the basis that one or more lane comes to an end at a particular point, and are discussed in further detail below. Other situations discussed following the below discussion on forced lane merges involve more optional lane changes or situations in which, due to driver preference or upcoming navigation directions, the driver and/or the operator of the nearby vehicle decide to change lanes. In both the lane merge and lane change context, system 100 may determine a future risk of collision based on an estimated proximity between the driver's vehicle and the nearby vehicle computed from one or more observed properties of the driver's vehicle and/or the nearby vehicle.

To detect an upcoming merge between the driver's vehicle lane and the nearby vehicle lane at step 130, system 100 may consult map data 109 based on the computed driver's vehicle location to check for a merge involving the driver's vehicle lane and the nearby vehicle lane within a certain forward distance of the driver's vehicle location at step 132. This optionally user-defined forward distance may be directly based on distance, for example, a check for a lane merge in the next two miles, or may be based on an optionally user-defined time period, with the corresponding distance computed based on the current driver's vehicle velocity. For example, if the driver's vehicle is traveling 60 miles per hour and the specified time period is one minute, system 100 may check for a merge involving the driver's vehicle lane and the nearby vehicle lane within one mile of the driver's vehicle location. Driver's vehicle velocity may be measured by system 100 by recording GPS satellite data over time, for example by batching driver's vehicle location data over an optionally user-defined time period, or it may be an input from the driver's vehicle, for example based on the same data source as that used by the driver's vehicle's speedometer. Thus at step 132, system 100 may determine that the driver's vehicle lane and the nearby vehicle lane will merge, allowing further processing and computation to occur as described below, and may store the determined distance from the driver's vehicle to the lane merge location, and optionally include the distance in a driver alert as discussed below. At step 132 system 100 may optionally compute the probability that the nearby vehicle lane will merge with the driver's vehicle lane, for example accounting for uncertainty in whether temporary changes to lane configuration such as construction remain in effect, and may determine whether the probability meets a lane merge threshold, for example by exceeding the threshold, before proceeding with additional computation and/or driver alert steps.

As mentioned above, nearby vehicles that may pose a collision risk to the driver's vehicle due to an upcoming lane merge may not be located in a lane directly adjacent to that of the driver's vehicle. For example, in the case a nearby vehicle is entering a roadway on an entrance ramp, system 100 may detect the nearby vehicle while it is still a distance from the driver's vehicle but on a lane that is heading toward and eventually merging with the lane of the driver's vehicle. In other instances, a roadway may be reducing from three lanes to two lanes and from two lanes or one lane (or directly from three lanes to one lane, for example due to construction). In such a case, a nearby vehicle two lanes from the lane of the driver's vehicle would form a possible collision risk on the basis that the driver's vehicle and the nearby vehicle may likely be forced to occupy the same lane in the near future.

With a lane merge involving the driver's vehicle lane and nearby vehicle lane detected, system 100 may, at step 140, evaluate the collision risk posed by the nearby vehicle by computing the estimated distance between the nearby vehicle and the driver's vehicle at the location of the lane merge. To accomplish this, at step 142, system 100 may first compute the nearby vehicle location based on the computed driver's vehicle location, map data 109, and sensor data 105. That is, features in sensor data 105 may be correlated to location based on corresponding map data 109 localized using the computed driver's vehicle location. This matching of sensor data 105 to map data 109 may have already occurred at step 122 thus simplifying the determination of nearby vehicle location. By tracking nearby vehicle location over time, for example by batching nearby vehicle location data over an optionally user-defined time period, system 100 may compute nearby vehicle velocity.

At step 144, computed nearby vehicle location and nearby vehicle velocity may be combined with computed driver's vehicle location and computed and/or measured driver's vehicle velocity to estimate the nearby vehicle location and driver's vehicle location, and thus the distance between the nearby vehicle and the driver's vehicle, at the location of the merge detected by system 100 based on map data 109. That is, the future locations of the nearby vehicle and the driver's vehicle may be determined based on the velocity of each and the known distance to the point that the nearby vehicle lane and the driver's vehicle lane merge, assuming that the nearby vehicle and the driver's vehicle maintain their current velocity. System 100 may also take into account upcoming changes in the speed limit of the roadway between the current position of the nearby vehicle and/or driver's vehicle and the lane merge location, and/or other factors that may reduce the velocity of the nearby vehicle and/or driver's vehicle such as a sharp bend in the road or a change in the surface or atmospheric conditions of the road, thereby assuming the velocity profile of each will decrease by an amount corresponding to the decrease in the speed limit or by an amount commensurate with a change in road conditions. To anticipate changes in velocity, system 100 may employ a model trained on a dataset including the velocities of vehicles encountering various road conditions such as bends in the roadway, fog, and/or wet or icy conditions, that may be included in a real-time update to map data 109 or another source of live road conditions. Such a model and training dataset may be further based on vehicle classification, for example including different velocity profiles for a passenger vehicle as compared to a semi-truck. The system may use the nearby vehicle classification that may be attached to each nearby vehicle detection and/or a known or user-provided classification of the driver's vehicle to select the most accurate estimated velocity profile for the driver's vehicle and nearby vehicle matching upcoming roadway changes that one or both may encounter. This estimated distance between the driver's vehicle and nearby vehicle at the location of the lane merge may form the basis for outputting of a driver alert as discussed below.

FIG. 1D depicts a similar exemplary process to FIG. 1C by which system 100 may be used to identify the lanes along which the driver's vehicle and a nearby vehicle are traveling, while FIG. 1D depicts the process by which system 100 may detect and make associated computations related to a lane change by the driver's vehicle and/or the nearby vehicle. That is, in FIG. 1D, system 100 may process image data 103, GPS satellite data 107, and sensor data 105 generated by the first sensor 102, the GPS satellite receiver 106, and the second sensor 104 respectively, in addition to processing map data 109. System 100 may then identify the driver's vehicle lane at step 110 by at step 112 computing driver's vehicle location and identifying the driver's vehicle lane at step 114, before identifying the nearby vehicle lane at step 120 and 122 and optionally assigning a confidence metric to the identification at step 124.

Following nearby vehicle lane identification, at step 160, system 100 may detect a lane change, specifically by first detecting the use of a turning signal on at least one of the driver's vehicle or the nearby vehicle at step 162. For example, system 100 may use an input from the driver's vehicle that indicates that a turning signal is active and that indicates which of the two turning signals it is that is active. Alternatively or additionally, system 100 may use first sensor 102 and/or second sensor 104 to monitor the appearance of the turning signals on the driver's vehicle, and provide an input to system 100 that indicates the left turning signal or right turning signal is active following detection of an active turning signal light. In a similar manner, system 100 may monitor the turning signals on the nearby vehicle based on the portion of the one or more turning signals of the nearby vehicle that are visible to first sensor 102 and/or second sensor 104. For example, only the turning signal on rear view mirror of the nearby vehicle closest to the driver's vehicle may be visible, in which case system 100 may monitor only the active status of this turning signal to determine the operator of the nearby vehicle intends to change lanes. In the event the one or more sensors of system 100, including first sensor 102 and second sensor 104, have the ability to detect, for example by a clear line sight, a plurality of turning signal lights on the driver's vehicle or the nearby vehicle, for example including a rear turning signal light, a side turning signal light, and a rear view mirror turning signal light, system 100 may monitor one or more of the plurality of lights, optionally including all lights, to increase the chance of detection of use of a turning signal on the driver's vehicle or the nearby vehicle.

Upon detection of an active turning signal on the driver's vehicle and/or a nearby vehicle, indicating the intention of the driver of the vehicle with the active turning signal to change lanes in the direction indicated by the turning signal, system 100 may at step 164 determine the probability the vehicle with the active turning signal will indeed change lanes. Determination of the probability that the lane change will occur may be based on factors such as whether the nearby vehicle with the active turning signal has space to merge into the targeted lane, whether one or more nearby vehicles or the driver's vehicle has their brakes applied thereby potentially forming a spot for the merging vehicle, e.g. detected by sensor 102 and/or sensor 104 by monitoring brake light status and/or detected by an input from the driver's vehicle itself indicating brake engagement, whether the lane the nearby vehicle with an active turning signal is targeting is a lane leading to an exit ramp or whether the nearby vehicle recently entered the roadway on an entrance ramp thereby in both cases potentially increasing the operator's need to complete the lane change, and/or whether an obstacle is present in the lane ahead of the nearby vehicle with an active turning signal, such as a slow-moving car, an animal, or a piece of debris, forcing the driver of the nearby vehicle to change lanes to avoid it. A probability based on one or more of these exemplary factors, and/or on other similar factors, may be computed and represent the likelihood the lane change will occur. In the case that both the driver's vehicle and the nearby vehicle have active turning signals, system 100 may compute the probability that at least one of the two vehicles will complete the lane change. System 100 may compare this probability to an optionally user-defined lane change threshold, and may not proceed further with computation and outputting of driver alerts unless and until the probability meets the lane change threshold, for example by exceeding the threshold.

Next, at step 170, in an optionally similar manner to step 140, system 100 may compute the expected location of the lane change and the estimated distance between the driver's vehicle and the nearby vehicle at the expected location of the lane change, wherein at least one of the driver's vehicle or the nearby vehicle may have an active turning signal detected by system 100. Similar to step 140, at step 172, this computation may involve computation of nearby vehicle location based on the computed driver's vehicle location, map data 109, and sensor data 105: features in sensor data 105 may be correlated to location based on corresponding map data 109 localized using the computed driver's vehicle location. By tracking nearby vehicle location over time, for example by batching nearby vehicle location data over an optionally user-defined time period, system 100 may compute nearby vehicle velocity.

At step 174, the expected location of the lane change, and spacing between the driver's vehicle and nearby vehicle at that expected location, may be computed based on factors similar to the exemplary factors informing the computation of the probability that the lane change will take place, such as space to merge in the targeted lane, the brake status one the driver's vehicle and/or one or more nearby vehicles, whether the driver's vehicle is changing to a lane leading to an exit ramp or recently entered the roadway on an entrance ramp, and/or whether an obstacle is present in the lane ahead of the nearby vehicle. The computation may additionally take into account the nearby vehicle location and/or velocity, and/or the driver's vehicle location and/or velocity, informing whether a space to merge will be available. To this end, system 100 may repeat a similar process used to compute nearby vehicle location and/or velocity at steps 142 and 172 for one or more nearby vehicles determined by system 100 to potentially influence the ability of the vehicle with an active turning signal to merge into the targeted lane, thereby computing the location and/or velocity of those one or more nearby vehicles. For example, the ability of the vehicle with an active turning signal to merge may depend on another nearby vehicle decreasing its velocity to create a merge space. However, if that additional nearby vehicle is instead increasing its velocity, the merge space may not be available and an expected lane change location further from the driver's vehicle may be computed.

To determine the velocity profiles of the driver's vehicle, the vehicle with the active turning signal, and/or one or more additional nearby vehicles, similar to the process described at step 144, system 100 may assume that the nearby vehicle and driver's vehicle maintain their current velocity and/or may take into account upcoming changes in the speed limit of the roadway and/or other factors that may prompt a velocity change in the driver's vehicle and/or nearby vehicle such as a sharp bend in the road and/or a change in the surface or atmospheric conditions of the road. As described at step 144, system 100 may employ a model to anticipate the velocity change in one or more of the vehicles in response to known upcoming changes in the roadway conditions that may be contained in an update to map data 109 or another source of live road conditions, and/or may be based on the classification of the one or more vehicles, for example as a passenger vehicle or a semi-truck.

Thus, by computing location and/or velocity of the driver's vehicle, vehicle with an active turning signal, and/or one or more additional nearby vehicles, system 100 may project into the near future the location of one or more of the aforementioned vehicles, and thus may determine the configuration of the roadway at the expected lane change location, and specifically the estimated distance between the driver's vehicle and the vehicle changing lanes at the point of the lane change. This estimated distance, or proximity, much like the estimated distance at the lane merge location computed at step 144 of FIG. 1C, may inform system 100's outputting of a driver alert as discussed below.

At step 150 in FIG. 1C and step 180 in FIG. 1D, system 100 may output a driver alert by first comparing the estimated distance between the driver's vehicle and the nearby vehicle with a proximity threshold. At step 152, this estimated distance may correspond to the distance between the driver's vehicle and the nearby vehicle at the location of the lane merge computed at step 144 while at step 182, this estimated distance may correspond to the distance between the driver's vehicle and the nearby vehicle at the expected location of the lane change computed at step 174. If system 100 determines the estimated distance between the driver's vehicle and the nearby vehicle meets the proximity threshold, for example if the estimated distance is less than the proximity threshold, system 100 may proceed to output a driver alert based on the potential collision risk represented by the nearby vehicle. This proximity threshold may be user-defined and may be set to a value that corresponds to a system designer or driver's tolerance for collision risk. For example if the threshold is set to 20 feet, system 100 may output a larger number of alerts than if the threshold is set to 10 feet, making the larger value more appropriate for a risk-adverse user. The proximity threshold may alternatively or additionally be set to a value that corresponds to the stopping distance of the driver's vehicle and/or the nearby vehicle, which in turn may be based on the classification assigned to the nearby vehicle. For example, the proximity threshold may be higher for a semi-truck than for a passenger vehicle.

At steps 154 and 184, system 100 may output the driver alert based on the determinations of steps 152 and 182 respectively as described above. The purpose of the driver alert may be to notify the driver of an upcoming collision risk with respect to a particular nearby vehicle or vehicles and may include one or more recommendations on how to respond to mitigate the risk. The driver alert may take the form of one more techniques including, for example, a visual display, an audio tone and/or output, a haptic output, an electronic signal transmission, or any combination thereof. To output the driver alert, system 100 may include an outputter that can include a visual display device, an audio output device, a haptic vibration and/or movement device, and/or an electronic signal transmitter. The outputter may be used, for example, to generate an audible tone and/or illuminate one or more indicator lights located on the dashboard, the center console, the rear view mirror, and/or one or more side mirrors of the driver's vehicle.

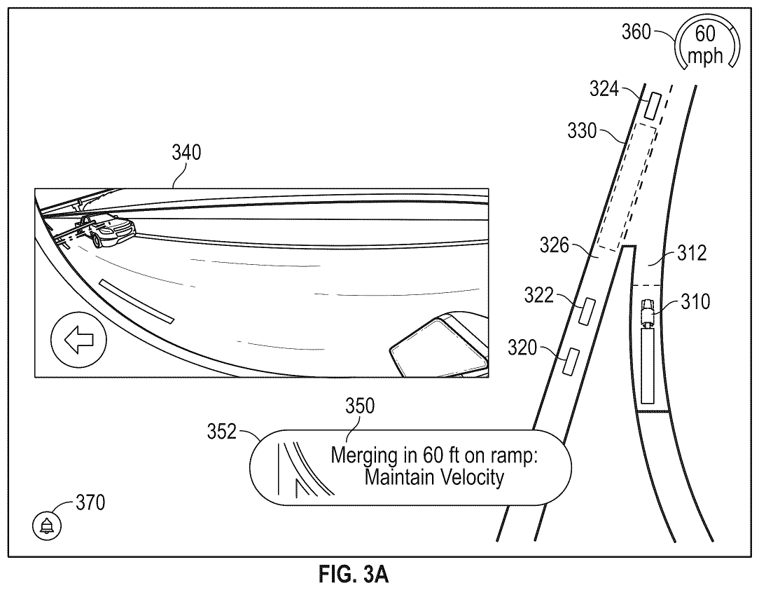

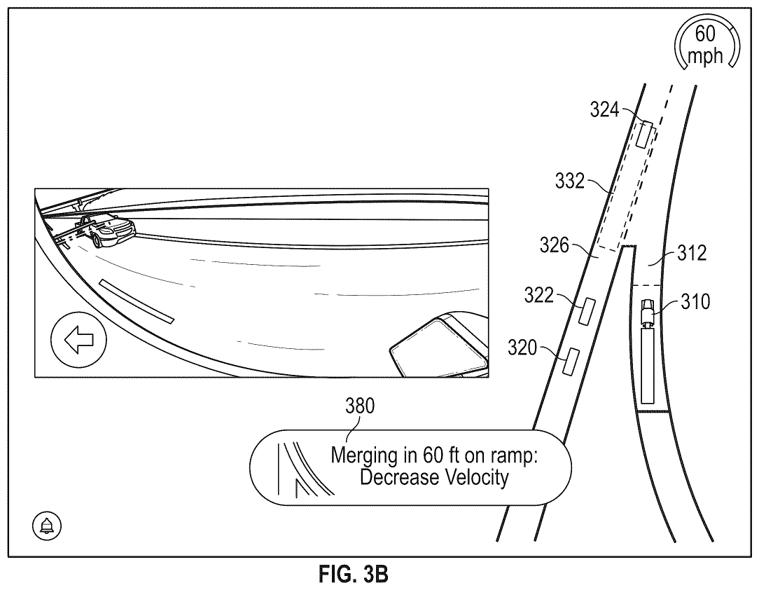

The driver alert may additionally or alternatively take the form of outputting of an alert on a user interface of system 100 that may be located, for example, at the center console of the driver's vehicle and may depict nearby vehicles and/or objects of concern and/or recommend steps the driver may take to mitigate collision risk. The user interface may take the form of, for example, a tablet or an integrated display located at the center console of the driver's vehicle, integrated into the driver's vehicle's windshield, or located at a different location in the vicinity of the driver. FIG. 3A depicts an exemplary user interface depicting a lane merge scenario in which the driver's vehicle 310 in the form of a semi-truck is merging, via entrance ramp 312, onto a roadway the includes pre-existing lane 326 as well as nearby vehicles 320, 322, and 324. Preceding generation of the user interface screen shown in FIG. 3A, system 100 may have identified the driver's vehicle lane and identified lane 326 as a nearby vehicle lane including nearby vehicles 320, 322, and 324 in the manner described above, and optionally determined that the nearby vehicle lane confidence metric met the nearby vehicle lane threshold. System 100 may have additionally determined that the lane the driver's vehicle was traveling along would form entrance ramp 312 and that the entrance ramp would merge with lane 326. Although it is not shown in FIG. 3A, for the purpose of this explanation, lane 312 is assumed to end in the near future forcing the driver to merge onto lane 326. Based on computations of the positions and velocities of nearby vehicles 320, 322, and 324, system 100 may have computed the estimated distances between driver's vehicle 310 each nearby vehicle at the location of the lane merge, which driver's vehicle 310 has very nearly reached in FIG. 3A. System 100 may have further determined that one or more of the estimated distances met a proximity threshold thereby warranting provision of some type of alert to the driver.

In FIG. 3A, the user interface-based alert is composed of a top-down view of the above-described scenario involving lane 326 and entrance ramp 312 as shown to the right of FIG. 3A which may update as the detected position of each vehicle changes. This top-down view includes a recommendation for the driver in the form of a recommended merge location or merge region in the form of area 330 that may match the size of the driver's vehicle, located between nearby vehicles 324 and 326. Other portions of the alert include icon 352 indicating to the driver that the alert relates to an entrance ramp merge and text 350 indicating the distance to the merge that may have been computed at step 132 and again an indication that the type of merge involves entering the roadway on an entrance ramp. The alert text may also include a velocity recommendation for the driver, such as maintaining, decreasing, or increasing the vehicle's velocity, which the driver may implement by manipulating the accelerator pedal and/or brake pedal of vehicle 310. In this case, alert text 350 includes a recommendation for the driver to maintain the velocity of vehicle 310 to merge into lane 326 at merge area 330. The alert may also comprise camera view 340, which may be generated by second sensor 104 or a different side-facing camera and may provide the driver a view of the one or more objects or nearby vehicles related to the alert. Camera view 340 may take the form of a video feed and/or a still image, providing the driver a recent view of the state of the roadway. User interface components active during the alert may also comprise an indication of the driver's vehicle's velocity 360, measured based on GPS satellite data 107 or based on a direct input from the driver's vehicle, and an icon 370 enabling control of alert volume, for alerts that combine generation of an audio tone and/or output with a user interface display. For such combined alerts system 100 may, in addition or as an alternative to a tone, output a voice alert that corresponds the alert text 350 and/or verbally describes the situation to the driver.

FIG. 3B depicts a modification of the lane merge scenario depicted in FIG. 3A: driver's vehicle 310 located on entrance ramp 312 is still merging with lane 326 along which nearby vehicles 320, 322, and 324 are traveling, however nearby vehicle 324 is located closer to driver's vehicle 310 than in FIG. 3A and now highlighted on the user interface, and the proposed merge location, now displayed as area 332 with a hatch pattern, can no longer accommodate driver's vehicle 310. As the area in lane 326 between nearby vehicles 324 and 322 is still fairly large, system 100 uses the hatch pattern on area 332 to emphasize that despite appearing large enough, it is not a sufficiently large merge area to accommodate the length of driver's vehicle 310. This determination of insufficient merge space may have been based on the estimated distance between driver's vehicle 310 and nearby vehicles 324 and 322 at the location of the lane merge, for example by determining that the distance is significantly less than the proximity threshold. Thus, instead of providing a recommended merge location at the point in time depicted in FIG. 3B, system 100 instead outputted modified alert text 380 recommending that the driver decrease the velocity of the vehicle, allowing nearby vehicles 320 and 322 to pass by before merging onto lane 326.

As an addition or alternative to the presence or absence of a hatch pattern in areas 330 and 332, system 100 may color an approved merge area such as 330 one color such as green and may color a merge area that may not accommodate the driver's vehicle such as 332 a different color such as red. Additionally, to highlight a nearby vehicle that represents a collision risk, for example nearby vehicle 324 in FIG. 3B, system 100 may apply a different color to the nearby vehicle than other nearby vehicles or than in situations in which the nearby vehicle does not represent a collision risk. For example other nearby vehicles or vehicles corresponding to no collision risk may be colored one color such as grey and vehicles corresponding to a collision risk may be colored a different color such as red. Alternatively or additionally, a pattern such as a hatch may be applied to one or more vehicles representing a collision risk, or the color and or pattern may change as a function of the estimated distance between the driver's vehicle and the nearby vehicle at the lane merge or lane change location.

Although not depicted, lane 312 of FIGS. 3A and 3B may be assumed to end off the screen, forcing driver's vehicle 310 to merge onto lane 326. However, in the hypothetical scenario in which lane 312 continued and formed a new lane, without subsequently forming an exit ramp or otherwise ending in the near future, driver's vehicle 310 would be at liberty to remain in lane 312 and not forced to merge. As system 100 may be aware of this fact based on map data 109 whereas the driver may expect to be required to merge, system 100 in this scenario may output a driver alert simply notifying the driver that a merge onto lane 326 is not required.

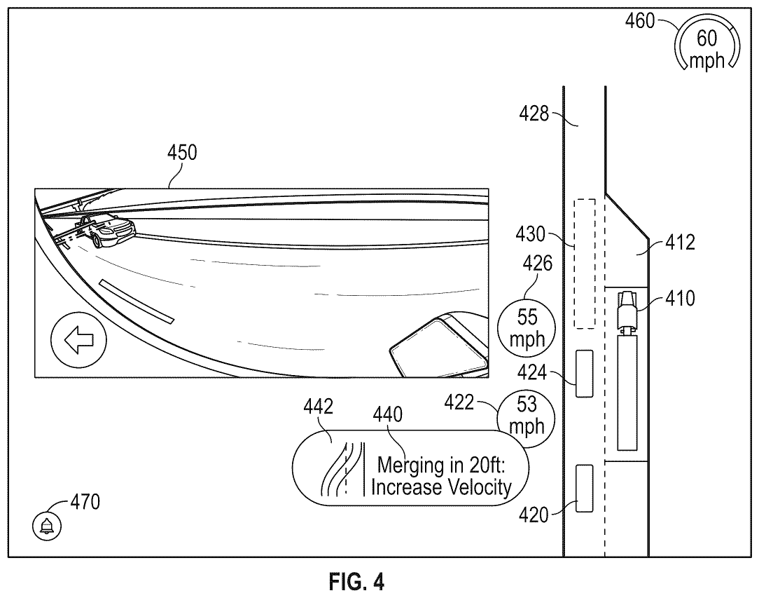

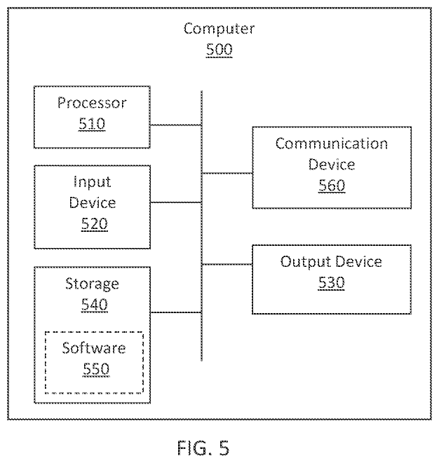

FIG. 4 depicts a user interface-based alert corresponding to an alternate lane merge scenario involving a reduction in lanes in which the lane driver's vehicle 410 is traveling along, lane 412, ends and driver's vehicle 410 is forced to merge onto lane 428 along which nearby vehicles 420 and 424 are traveling. Here, as with alerts depicted in FIGS. 3A and 3B, the user interface-based alert includes a top-down view of the scenario, side-facing camera view 450, and an icon 470 controlling the audio aspect of the alert. As in the case of the alert depicted in FIG. 3A, the alert contains a recommended merge area 430 in front of nearby vehicles 420 and 424. The alert icon 442 reflects the merge as resulting from a reduction in lanes and alert text 440 reflects that there is a reduced amount of space (20 feet) left to merge at recommended merge area 430, therefore recommending the driver to increase the vehicle's velocity to complete the merge. The alert of FIG. 4 also includes an indication of the velocities of nearby vehicles 420 and 426 in the form of bubbles 422 and 426 respectively. If the user interface updates as the position of each detected nearby vehicle changes, bubbles 422 and 426 that may follow the motion of the respective nearby vehicle. The driver may thus use the indication of the velocities of nearby vehicles 420 and 426 relative to the velocity of driver's vehicle 410 displayed at velocity indication 460 to independently gauge how to modify the velocity of driver's vehicle 410 and/or to confirm the recommended merge area represents the best approach.

If the estimated distance between the driver's vehicle and two or more nearby vehicles at the location of the lane merge or expected lane change is determine to meet the proximity threshold, system 100 may output a driver alert focusing on the nearby vehicle with the lowest estimated distance, and/or may output a driver alert that highlights each of the two or more nearby vehicle. If an estimated distance between the driver's vehicle and a nearby vehicle initially met the proximity threshold but changes such that it no longer meets the threshold, for example by exceeding the threshold, system 100 may cancel the driver alert, optionally notifying the driver that the nearby vehicle no longer represents a significant collision risk.

The one or more forms of driver alerts, including generation of an audible tone and/or output, a haptic output, an electronic signal transmission, an illumination of one or more indicator lights, and/or the various implementations of visual display and/or user interface-based alerts including top-down views indicating roadway lanes and nearby vehicles, side camera views, and alert texts discussed above may also apply to scenarios involving lane changes, or optional lane merges. As discussed in the context of FIG. 1D, such alerts may be based on the estimated distance between the driver's vehicle and the nearby vehicle at the expected lane change location, whether the vehicle changing lanes is the driver's vehicle, a nearby vehicle, or both vehicles. Thus, system 100 may provide an indication of lane change area, similar to areas 330, 332, or 430, in an adjacent lane if the driver is changing lanes, alert text similar to texts 350, 380, or 440 indicating the distance to the expected lane change location and/or a recommendation to modify or maintain the velocity of the vehicle. If more than one lane change is expected to occur, for example as a result of system 100 detecting an active turning signal on two or more nearby vehicles, system 100 may output a driver alert that focuses on the lane change expected to occur first (for example corresponding to the lowest distance between the driver's vehicle and the expected lane change location), that focuses on the nearby vehicle that may be expected to pass closest to the driver's vehicle (for example corresponding to the lowest estimated distance between the driver's vehicle and the nearby vehicle at the expected lane change location), that encompasses all expected lane changes, or some combination thereof. In combining the processes of FIGS. 1C and 1D, corresponding to lane merges and lane changes, system 100 may compute the probability that the driver's vehicle will enter the lane of a nearby vehicle, that the nearby vehicle will enter the lane of the driver's vehicle, or that the driver's vehicle lane and the nearby vehicle lane will merge, and may base outputting of a driver alert on whether the probability meets an alert threshold, for example by exceeding the threshold.

In one or more examples, the disclosed systems and methods utilize or may include a computer system. FIG. 5 depicts an exemplary computing system according to one or more examples of the disclosure. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for a driver assistance system of a driver's vehicle, the method comprising:
detecting a location of the driver's vehicle and a lane that the driver's vehicle is traveling along;
identifying a nearby vehicle in a vicinity of the driver's vehicle based on sensor data;
identifying a lane that the nearby vehicle is traveling along based on the location of the driver's vehicle, map data comprising traffic lane information, and the sensor data;
determining, based on the driver's vehicle lane and the nearby vehicle lane, that the driver's vehicle lane and the nearby vehicle lane will merge; and
outputting a driver alert based on the determination.

2. The method of claim 1, wherein detecting the location of the driver's vehicle is based on global positioning system satellite data.

3. The method of claim 1, wherein detecting the location of the driver's vehicle and the lane that the driver's vehicle is traveling along is based on matching one or more detected lane lines of a roadway that the driver's vehicle is traveling along to the map data comprising traffic lane information.

4. The method of claim 1, wherein detecting the location of the driver's vehicle and the lane that the driver's vehicle is traveling along is based on global positioning system satellite data, the map data comprising traffic lane information, and one or more detected lane lines of a roadway that the driver's vehicle is traveling along.

5. The method of claim 1, wherein identifying the nearby vehicle lane comprises adding the map data comprising traffic lane information to the sensor data and determining that a nearby vehicle lane confidence metric meets a nearby vehicle lane threshold.

6. The method of claim 1, wherein determining that the driver's vehicle lane and the nearby vehicle lane will merge is further based on the map data comprising traffic lane information.

7. The method of claim 1, wherein outputting the driver alert comprises computing a nearby vehicle location and a nearby vehicle velocity based on the driver's vehicle location, the map data, and the sensor data.

8. The method of claim 7, wherein outputting the driver alert comprises computing an estimated distance between the driver's vehicle and the nearby vehicle at a location of the merge based on the driver's vehicle location, a driver's vehicle velocity, the nearby vehicle location, and the nearby vehicle velocity.

9. The method of claim 8, wherein outputting the driver alert is further based on a determination that the estimated distance between the driver's vehicle and the nearby vehicle at the location of the merge meets a proximity threshold.

10. The method of claim 1, wherein outputting the driver alert comprises at least one of illuminating an indication light or generating an audible tone.

11. The method of claim 1, wherein outputting the driver alert comprises displaying, on a user interface, at least one of an indication of the nearby vehicle, a recommended merge location, or a recommendation to modify or maintain a velocity of the driver's vehicle.

12. A method for a driver assistance system of a driver's vehicle, the method comprising:
detecting a location of the driver's vehicle and a lane that the driver's vehicle is traveling along;
identifying a nearby vehicle in a vicinity of the driver's vehicle based on sensor data;
identifying a lane that the nearby vehicle is traveling along based on the location of the driver's vehicle, map data comprising traffic lane information, and the sensor data;
computing a probability, based on the driver's vehicle lane and the nearby vehicle lane, that at least one of the following will occur: the driver's vehicle will enter the nearby vehicle lane or the nearby vehicle will enter the driver's vehicle lane; and
outputting a driver alert based on the probability.

13. The method of claim 12, wherein detecting the location of the driver's vehicle is based on global positioning system satellite data.

14. The method of claim 12, wherein detecting the location of the driver's vehicle and the lane that the driver's vehicle is traveling along is based on matching one or more detected lane lines of a roadway that the driver's vehicle is traveling along to the map data comprising traffic lane information.

15. The method of claim 12, wherein detecting the location of the driver's vehicle and the lane that the driver's vehicle is traveling along is based on global positioning system satellite data, the map data comprising traffic lane information, and one or more detected lane lines of a roadway that the driver's vehicle is traveling along.

16. The method of claim 12, wherein identifying the nearby vehicle lane comprises adding the map data comprising traffic lane information to the sensor data and determining that a nearby vehicle lane confidence metric meets a nearby vehicle lane threshold.

17. The method of claim 12, wherein determining the probability is further based on detecting use of a turning signal on at least one of the driver's vehicle or the nearby vehicle.

18. The method of claim 12, wherein outputting the driver alert comprises computing a nearby vehicle location and a nearby vehicle velocity based on the driver's vehicle location, the map data, and the sensor data.

19. The method of claim 18, wherein outputting the driver alert comprises computing an expected lane change location and an estimated distance between the driver's vehicle and the nearby vehicle at the expected lane change location based on the driver's vehicle location, a driver's vehicle velocity, the nearby vehicle location, and the nearby vehicle velocity.

20. The method of claim 19, wherein outputting the driver alert is further based on a determination that the estimated distance between the driver's vehicle and the nearby vehicle at the expected lane change location meets a proximity threshold.

21. The method of claim 12, wherein outputting the driver alert comprises at least one of illuminating an indication light or generating an audible tone.

22. The method of claim 12, wherein outputting the driver alert comprises displaying, on a user interface, at least one of an indication of the nearby vehicle, a recommended lane change location, or a recommendation to modify or maintain a velocity of the driver's vehicle.

23. A driver assistance system of a driver's vehicle, the driver assistance system comprising:
a first sensor to detect one or more lane lines of a roadway that the driver's vehicle is traveling along;
a second sensor to detect a nearby vehicle in a vicinity of the driver's vehicle;
a global positioning system satellite receiver; and
one or more processors and memory storing instructions that, when executed by the one or more processors, cause the system to:
detect a location of the driver's vehicle and a lane that the driver's vehicle is traveling along;
identify a nearby vehicle in a vicinity of the driver's vehicle using data from the second sensor;
identify a lane that the nearby vehicle is traveling along based on the location of the driver's vehicle, map data comprising traffic lane information, and data from the second sensor;
compute, based on the driver's vehicle lane and the nearby vehicle lane, a probability that at least one of the following will occur: the driver's vehicle will enter the nearby vehicle lane, the nearby vehicle will enter the driver's vehicle lane, or the driver's vehicle lane and the nearby vehicle lane will merge; and
output a driver alert based on the probability.

24. A non-transitory computer readable storage medium storing instructions for a driver assistance system of a driver's vehicle, wherein the instructions, when executed by one or more processors of an electronic device, cause the device to:
detect a location of the driver's vehicle and a lane that the driver's vehicle is traveling along;
identify a nearby vehicle in a vicinity of the driver's vehicle using data from the second sensor;
identify a lane that the nearby vehicle is traveling along based on the location of the driver's vehicle, map data comprising traffic lane information, and data from the second sensor;
compute, based on the driver's vehicle lane and the nearby vehicle lane, a probability that at least one of the following will occur: the driver's vehicle will enter the nearby vehicle lane, the nearby vehicle will enter the driver's vehicle lane, or the driver's vehicle lane and the nearby vehicle lane will merge; and
output a driver alert based on the probability.
